(19) United States
(12) Patent Application Publication
(10) Pub. No.: US 2009/0247344 A1
(43) Pub. Date: Oct. 1, 2009

(54) SHIFT CONTROL APPARATUS FOR AUTOMATIC TRANSMISSION

(75) Inventor: Takayuki KUBO, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/397,902

(22) Filed: Mar. 4, 2009

(30) Foreign Application Priority Data
Mar. 28, 2008 (JP) 2008-085343

(51) Int. Cl. B60W 10/10

(52) U.S. Cl. 475/125

(57) ABSTRACT

Strain gauges and a torque value calculating unit detect a value for torque acting on a sun gear, based on a reaction force. A torque phase detecting unit detects start of a torque phase at which only torque distribution changes while a gear ratio stays at the same level as before upshift, based on a change in the value for torque detected by the strain gauges and the torque value calculating unit. Consequently, when upshifting, an end of a piston stroke can be accurately determined by precisely detecting the torque phase during the shifting. Thus, problems such as burning of friction materials due to excessive heat generation in friction engagement elements can be eliminated.

### INCORPORATION BY REFERENCE

The disclosure of Japanese Patent Application No. 2008-085343 filed on Mar. 28, 2008 including the specification, drawings and abstract is incorporated herein by reference in its entirety.

### BACKGROUND OF THE INVENTION

1. Field of the Invention

The present invention relates to a shift control apparatus for an automatic transmission mounted on a vehicle such as an automobile, and particularly to a shift control apparatus for an automatic transmission that is capable of precisely detecting a torque phase during shifting.

2. Description of the Related Art

In general, a stepped automatic transmission mounted on a vehicle performs shifting by controlling the engagement/disengagement (“state”) of a plurality of friction engagement elements (clutches and/or brakes) using a hydraulic control device, and thereby provides power transmission paths corresponding to the different shift speeds (gear ratios) in a speed change gear mechanism. A shift control apparatus for controlling the shifting of the automatic transmission maintains shift shocks within a permissible range, by controlling the timing of the shifting in accordance with the amount of rotational speed change (acceleration) detected during the shifting.

A hydraulic control device for automatic transmission shift control as described above is disclosed, for example, in Japanese Patent Application Publication (“Kokai”) No. JP-A-2005-282810. This hydraulic control device, during upshift, responsive to a command from an electronic control for connection (engagement) command pressure to a solenoid in a hydraulic control unit by the time when a shelf pressure is reached, corrects the connection command pressure downward if a maximum rate of change of gear ratio is larger than a rate of change of a thrust-up determination gear ratio, whereas the connection command pressure is corrected upward if the maximum rate of change of a gear ratio is smaller than a rate of change of a prolongation determination gear ratio. This hydraulic control device as described above can suppress, to a low level, the change in acceleration of a vehicle over the interval from the torque phase to the initial stage of the inertia phase during upshift, and can thus stabilize the output shaft torque to some extent.

### SUMMARY OF THE INVENTION

An automatic transmission such as the one described in the Kokai publication mentioned above often determines end of a piston stroke (end of so-called backlash reduction) by detecting the amount of change in rotation acceleration. Therefore, if a piston stroke is excessive, the excessiveness of the stroke has been reliably detected at a low gear stage because a change occurs in the rotation acceleration. However, in a high gear stage, because a change in the rotation acceleration is unlikely to occur, the control has often been performed on the side of safety, that is, on the side of tie-up, from the viewpoint of prevention of engine racing, thus creating a possibility of occurrence of problems such as burning of friction materials due to excessive heat generation in the friction engagement elements.

Therefore, it is an object of the present invention to provide a shift control apparatus for an automatic transmission that is capable of eliminating the possibility of occurrence of problems such as burning of friction materials due to excessive heat generation in the friction engagement elements, by accurately determining the end of piston stroke through precise detection of the torque phase during shifting when performing an upshift by switching engagement states such as in a clutch-to-clutch shift.

The present invention provides a shift control apparatus for an automatic transmission that includes a stepped speed change mechanism that receives rotation of a driving source at an input shaft and couples an output member to drive wheels, a plurality of friction engagement elements that change power transmission paths between the input shaft and the output member, and hydraulic servos that disconnect and connect the friction engagement elements. The speed change mechanism includes a fixed gear that is fixed to a transmission case to generate a reaction force against the rotation of the input shaft, and achieves an upshift to a predetermined shift speed by engaging a first friction engagement element and disengaging a second friction engagement element. The shift control apparatus includes: a fixed gear torque detecting unit that detects, based on the reaction force, a value for torque acting on the fixed gear; and a torque phase detecting unit that detects, based on a change in the torque value detected by the fixed gear torque detecting unit, start of a torque phase at which only torque distribution changes while the gear ratio stays at the level before the upshift.

The fixed gear torque detecting unit detects the value for torque acting on the fixed gear based on the reaction force of the fixed gear, and the torque phase detecting unit detects, based on the change in the torque value detected by the fixed gear torque detecting unit, the start of the torque phase at which only the torque distribution changes while the gear ratio remains unchanged, i.e. stays at the level before the upshift. Therefore, when upshifting by switching of engagement states such as in a clutch-to-clutch shift, the end of the piston stroke can be accurately determined by precisely detecting the torque phase during the shifting, thereby enabling improvement in responsiveness during the shifting, reduction of waiting time, and elimination of possibility of occurrence of problems such as burning of friction materials due to excessive heat generation in the friction engagement elements. In addition, because the torque phase detecting unit detects the start of the torque phase, the end of the piston stroke can be accurately determined in the region in which it cannot otherwise be determined, i.e. at a comparatively high gear stage. Therefore, in the present invention, for example, by learning control of the engagement pressure of the piston stroke, the piston stroke in the high gear stage can be optimized, thus effectively preventing engine racing and excessive heat generation.

Accordingly, in one aspect of the present invention, the change in the torque value detected by the fixed gear torque detecting unit appears prominently during shifting between comparatively high shift speeds, and the torque phase detecting unit detects the start of the torque phase by determining the time when the torque value prominently changes as the end of a piston stroke. Therefore, the start of the torque phase can be easily detected by determining the prominent change in the torque value acting on the fixed gear.

According to another aspect of the present invention, the fixed gear torque detecting unit is composed of: a strain detecting sensor that detects strain between the fixed gear and the transmission case caused by the torque acting from the input shaft side; and a torque value calculating unit that calculates the value for torque acting on the fixed gear, based on the strain detected by the strain detecting sensor.

A strain gauge of a simple structure and comparatively low cost can be used as the strain detecting sensor Further, because the strain between the fixed gear and the transmission case is easily detected by, for example, directly adhering the strain gauge on the fixed gear, it is possible to realize detection of the torque value and, therefore, the torque phase with an extremely simple structure.

According to another aspect of the present invention, the shift control apparatus further includes: a hydraulic pressure control unit that controls, during the torque phase, an engaging-side hydraulic pressure acting on the hydraulic servo for the first friction engagement element and a disengaging-side hydraulic pressure acting on the hydraulic servo for the second friction engagement element. The hydraulic pressure control unit controls the engaging-side hydraulic pressure and the disengaging-side hydraulic pressure, based on detection of the start of the torque phase by the torque phase detecting unit.

Therefore, although the prior art has not been able to accurately identify the end of the piston stroke, particularly during shifting between high gear stages, the present invention enables accurate identification of the end of the piston stroke by use of the torque phase detecting unit. Thus, switching to the torque phase control can be made quicker than heretofore possible, and excessive heat generation in the friction engagement elements during the torque phase is prevented.

According to yet another aspect of the present invention, the speed change mechanism includes: a decelerating planetary gear set that outputs rotation at a speed that is decelerated from that of the input shaft; a planetary gear unit that has four rotary elements including an output element connected to the output member of the speed change mechanism; two decelerating clutches that, when engaged, transmit rotation of the decelerating planetary gear set to, respectively, two of the rotary elements of the planetary gear unit; and an input clutch that, when engaged, transmits rotation of the input shaft to one of the rotary elements of the planetary gear unit, thereby achieving five or six forward speeds. The fixed gear is a gear that is constantly held stationary (without rotation) in the decelerating planetary gear set.

Therefore, by using a comparatively simple structure which is merely a strain detecting sensor or the like attached to the transmission case, the torque phase can be detected early and accurately and the detection of the start of the torque phase can be used for shift control.

In addition, in an aspect of the present invention, the decelerating planetary gear set is composed of a sun gear set that is fixed to the transmission case, a ring gear that outputs the decelerated rotation, and a carrier that receives the rotation of the input shaft. The fixed gear is the sun gear.

Therefore, by using a comparatively simple structure, which is merely a strain detecting sensor or the like attached on the sun gear in manufacture of the speed change mechanism including the sun gear fixed to the transmission case, the torque phase can be detected early and accurately and can be used for shift control.

### BRIEF DESCRIPTION OF THE DRAWINGS

FIG. 1 is a block diagram of a shift control apparatus for an automatic transmission according to the present invention;

FIG. 2 is a skeletal diagram of an automatic speed change mechanism to which the present invention can be applied;

FIG. 3 is an engagement table for the automatic speed change mechanism;

FIG. 4 is a velocity diagram for the automatic speed change mechanism;

FIG. 5 is a diagram showing a stationary sun gear provided in a planetary gear set in the automatic speed change mechanism, and also showing strain gauges fixed to the sun gear;

FIG. 6 is a schematic diagram of a hydraulic circuit in a hydraulic control device of the shift control apparatus;

FIG. 7 is a flow chart of operation of the shift control apparatus of FIG. 1;

FIG. 8 is a time chart illustrating detection of a torque phase by the shift control apparatus for the automatic transmission;

FIG. 9 is a time chart for control in the above-described related art;

FIG. 10 is a time chart showing changes in parameters in a modified embodiment;

FIG. 11 is a time chart showing changes in the parameters in the modified embodiment; and

FIG. 12 is a time chart showing changes in the parameters in the modified embodiment.

### DETAILED DESCRIPTION OF THE EMBODIMENTS

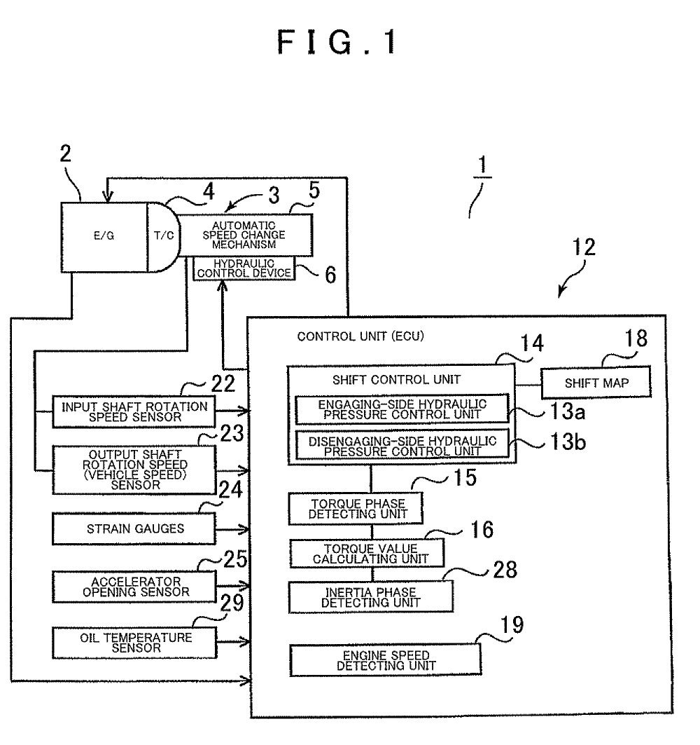

An embodiment of the present invention will be described below with reference to FIGS. 1 to 12.

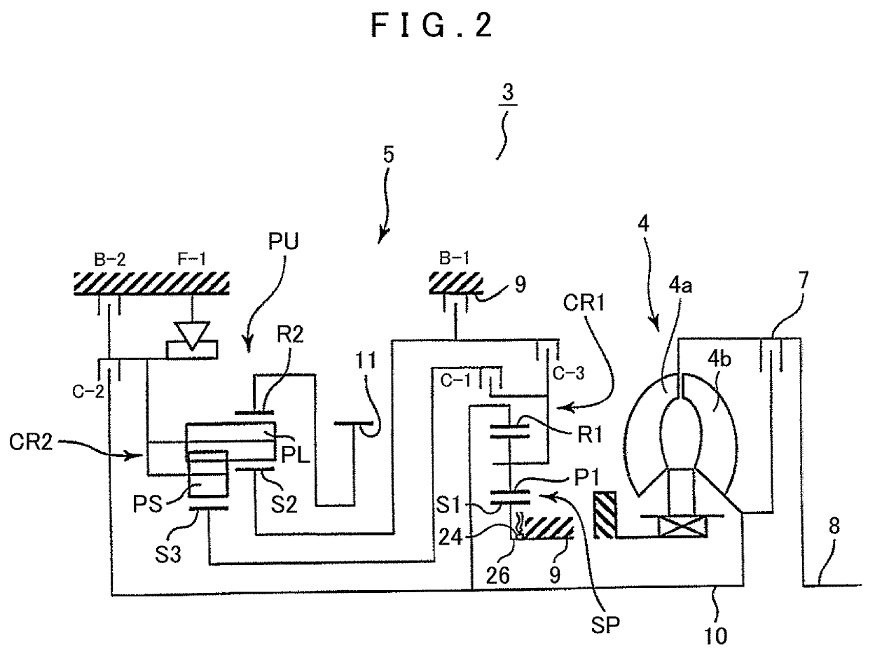

First, the structure of an automatic transmission 3 to which the present invention can be applied will be described with reference to FIG. 2. As shown in FIG. 2, an automatic transmission 3 that is suitable for use in, for example, an FF (front engine, front drive) type vehicle has an input shaft 8 that can be connected to an engine 2 (refer to FIG. 1) serving as a driving source, and is provided with a torque converter 4 and an automatic speed change mechanism (speed change mechanism) 5 with their centers aligned along the axis of the input shaft 8. A transmission case 9 houses the automatic speed change mechanism 5.

The automatic transmission 3 is a stepped automatic transmission that has clutches C-1, C-2, and C-3, and brakes B-1 and B-2 serving as friction engagement elements (engagement elements) whose engagement states establish a plurality of corresponding power transmission paths in the automatic speed change mechanism 5, to provide six forward speeds. However, the present invention can be applied, not only to an automatic transmission with six forward speeds, but also to an automatic transmission having five forward speeds.

The torque converter 4 has a pump impeller 4a connected to the input shaft 8 of the automatic transmission 3, and a turbine runner 4b to which the rotation of the pump impeller 4a is transmitted through hydraulic fluid. The turbine runner 4b is connected to an input shaft 10 of the automatic speed change mechanism 5 arranged coaxially with the input shaft 8. In addition, the torque converter 4 is provided with a lockup clutch 7, and when the lockup clutch 7 is engaged under control of a hydraulic control device 6 (refer to FIG. 1), the rotation of the input shaft 8 of the automatic transmission 3 is directly transmitted to the input shaft 10 of the automatic speed change mechanism 5. The hydraulic control device 6 is provided with multiple hydraulic servos (not shown) for operation of the automatic speed change mechanism 5, as well as multiple shift valves for switching hydraulic pressure to these hydraulic servos.

The automatic speed change mechanism 5 is provided with a planetary gear set SP and a planetary gear unit PU on the input shaft 10. The planetary gear set SP is a so-called single pinion planetary gear set including a sun gear (fixed gear) S1, a carrier CR1, and a ring gear R1, the carrier CR1 having a pinion P1 that meshes with the sun gear S1 and the ring gear R1. The sun gear S1 is a gear that is constantly held stationary (without rotation). The planetary gear set SP serves as a decelerating planetary gear set that outputs rotation at a speed that is decelerated from the rotational speed of the input shaft 10.

The planetary gear unit PU is a so-called Ravigneaux type planetary gear unit that includes a sun gear S2, a sun gear S3, a carrier CRC, and a ring gear R2 as four rotary elements, the carrier CR2 having a long pinion PL that meshes with the sun gear S2 and the ring gear R2, and a short pinion PS that meshes with the sun gear S3. The clutches C-3 and C-1 serve as decelerating clutches that can be engaged to transmit rotation of the planetary gear set SP to the respective sun gears S2 and S3. In addition, the clutch C-2 serves as an input clutch that can be engaged to transmit rotation of the input shaft 10 to the carrier CR2. The ring gear RX is an output element connected to an output shaft (not shown) of the automatic speed change mechanism 5.

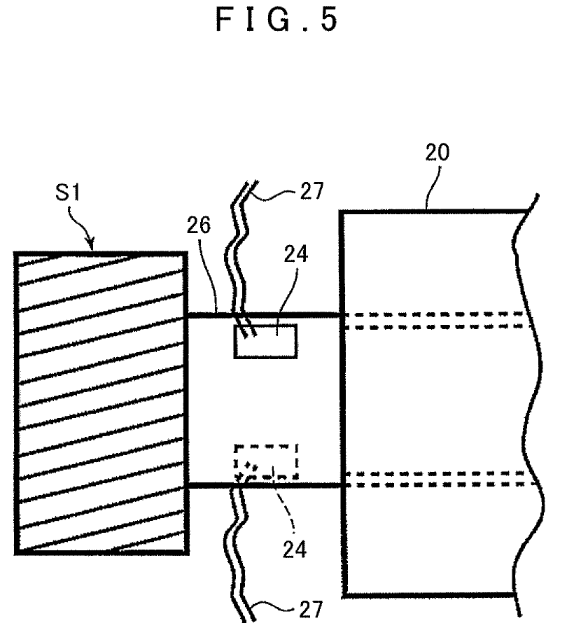

As shown in FIGS. 2 and 5, the sun gear S1 of the planetary gear set SP is a gear that is fixed to the transmission case 9 to generate a reaction force against the rotation of the input shaft 10. More specifically, the sun gear S1 is connected through a spline connection to a boss 20 fixed to the transmission case 9 and is thereby constantly held stationary. To a shaft portion 26 of the sun gear S1, a strain gauge 24 that detects strain on the sun gear S1 (that is, the shaft portion 26), corresponding to the torque acting from the input shaft 10 side, is directly fixed by adhesive or the like. The strain gauge 24 serves as a strain detecting sensor for detecting the strain between the sun gear S1 and the transmission case 9 caused by the torque acting from the input shaft 10 side.

The strain gauge 24 fixed to the shaft portion 26 is also fixed to a portion on the opposite side of the shaft portion 26. Thus, the strain is detected by two strain gauges fixed to the outer circumferential surface of the shaft portion 26. The strain gauges 24 are connected to a control unit 12 through electrical connection cables 27. The number of strain gauges 24 is not limited to two and strain gauges 24 can be fixed to three or four positions on the outer circumferential surface of the shaft portion 26 at even angular intervals.

As shown in FIG. 2, the ring gear R1 rotates integrally with the input shaft 10, i.e. with the “input rotation”. The carrier CR1 rotates at a speed that is decelerated from the speed of the input rotation by the fixed sun gear S1 and the ring gear R1. The carrier CR1 is connected to the clutch C-1 and the clutch C-3.

The sun gear S2 of the planetary gear unit PU can be fixed to the transmission case 9 by engagement of the brake (engagement element) B-1, and can also be connected by engagement of the clutch C-3 to receive the decelerated rotation from the carrier CR1. In addition, the sun gear S3 can be connected by engagement of the clutch C-1 to receive the decelerated rotation input from the carrier CR1.

The carrier CR2 can be connected by engagement of the clutch C-2 to receive the rotation input from the input shaft 10. The carrier CR2 is also connected to a one-way clutch (engagement element) F-1 and the brake B-2, and is thereby restricted to rotation in one direction relative to the transmission case 9 by the one-way clutch F-1 and can be held stationary by engagement of the brake B-2. The ring gear R2 is connected to a counter gear 11, and the counter gear 11 is connected to drive wheels (not shown) through a counter shaft (not shown) and a differential device (not shown).

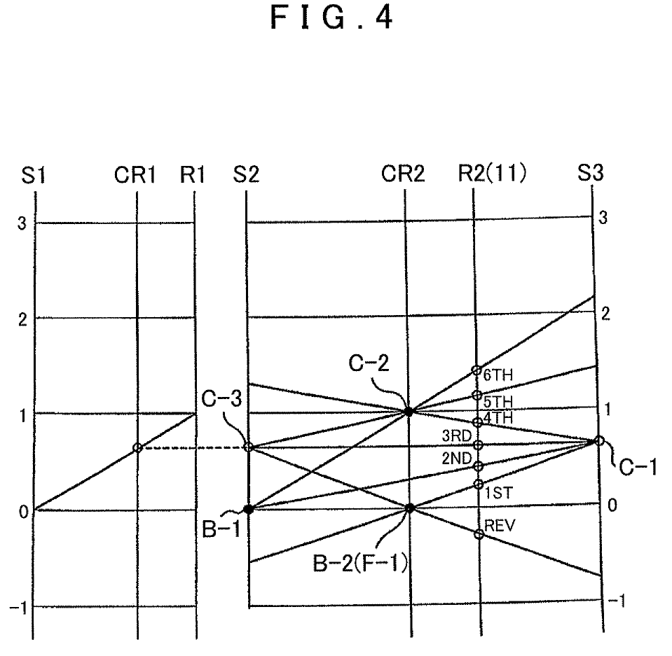

Next, the operation of the automatic speed change mechanism 5 will be described with reference to FIGS. 2, 3, and 4. Note that, in the velocity diagram shown in FIG. 4, each vertical axis represents the rotational speed of a corresponding rotary element (gear), and the horizontal axis represents gear ratios of those rotary elements. In addition, in the planetary gear set SP section of the velocity diagram, the vertical axes correspond to the sun gear S1, the carrier CR1, and the ring gear R1, in order from the left in FIG. 4. In the planetary gear unit PU section of the velocity diagram, the vertical axes correspond to the sun gear S3, the ring gear R2, the carrier CR2, and the sun gear S2, in that order from the right in FIG. 4.

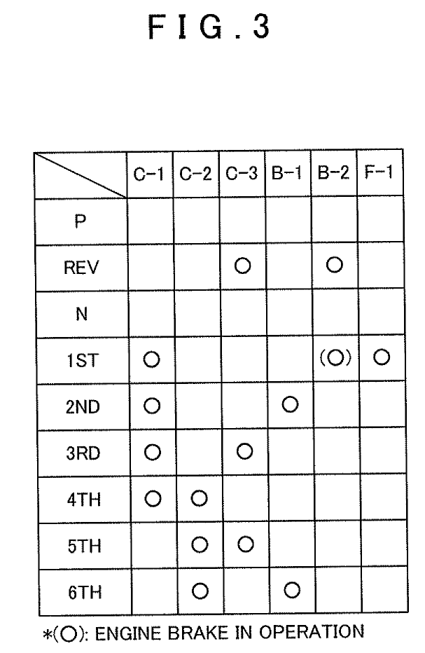

For example, in the forward first speed (1ST) in the D (drive) range, the clutch C-1 and the one-way clutch F-1 are engaged, as shown in FIG. 3. Then, as shown in FIGS. 2 and 4, the rotation of the carrier CR1, which is driven by the ring gear R1 in cooperation with the fixed sun gear S1 at a speed decelerated from that of the input rotation of ring gear R1 (hereinafter “decelerated rotation”), is transferred to the sun gear S3 through engagement of the clutch C-1. In addition, the rotation of the carrier CR2 is restricted to one direction (forward rotating direction). The carrier CR2 is prevented from rotating in the reverse direction and held in the fixed state. Then, the decelerated rotation introduced to the sun gear S3 is output to the ring gear R2 through the fixed carrier CR2. Thus, the forward rotation as the first forward speed is output from the counter gear 11.

In engine braking (coasting), the above-described state of the first forward speed is maintained in the manner in which the brake B-2 is locked to fix the carrier CR2 so that the carrier CR1 is prevented from rotating forward. Moreover, because the carrier CR2 is prevented from rotating in the reverse direction and allowed to rotate forward by the one-way clutch F-1 in the first forward speed, the first forward speed can be achieved more smoothly by automatic engagement of the one-way clutch F-1, in the case, for example, of a shift from a non-drive range to a drive range.

In the second forward speed (2ND), the clutch C-1 is engaged and the brake B-1 is locked, as shown in FIG. 3. Then, as shown in FIGS. 2 and 4, the decelerated rotation of the carrier CR1 is introduced to the sun gear S3 through the clutch C-1. In addition, the sun gear S2 is held stationary by the locking of the brake B-1. Then, the carrier CR2 rotates with a decelerated rotation slower than that of the sun gear S3, and the decelerated rotation introduced to the sun gear S3 is output to the ring gear R2 through the carrier CR2. Thus, the forward rotation as the second forward speed is output from the counter gear 11.

Note that, if the clutch C-1 is released from its state in the second forward speed (to a slipping state) by neutral control, the ring gear R2 is allowed to rotate forward and prevented from rotating reversely by the one-way clutch F-1 which operates to prevent the reverse rotation of the carrier CR2. Thus, the state of so-called hill holding is achieved, in which the reverse motion of the vehicle (reverse rotation of drive wheels) is prevented.

In the third forward speed (3RD), the clutch C-1 and the clutch C-3 are engaged, as shown in FIG. 3. Then, as shown in FIGS. 2 and 4, the decelerated rotation of the carrier CR1 is introduced to the sun gear S3 through the clutch C-1. In addition, the decelerated rotation of the carrier CR1 is introduced to the sun gear S2 by the engagement of the clutch C-3. Because the decelerated rotation of the carrier CR1 is introduced to the sun gear S2 and the sun gear S3, the planetary gear unit PU rotates at the decelerated speed (“decelerated rotation”) in a directly connected state, and the decelerated rotation is directly output to the ring gear R2. Thus, the forward rotation as the third forward speed is output from the counter gear 11.

In fourth forward speed (4TH), the clutch C-1 and the clutch C-2 are engaged, as shown in FIG, 3. Then, as shown in FIGS. 2 and 4, the decelerated rotation of the carrier CR1 is introduced to the sun gear S3 through the clutch C-1. In addition, the input rotation is introduced to the carrier CR2 by the engagement of the clutch C-2. Then, a decelerated rotation faster than that of the third forward speed is produced by the decelerated rotation introduced to the sun gear S3 and the input rotation introduced to the carrier CR2, and is output to the ring gear R2. Thus, the forward rotation as the fourth forward speed is output from the counter gear 11.

In fifth forward speed (5TH), the clutch C-2 and the clutch C-3 are engaged, as shown in FIG. 3. Then, as shown in FIGS. 2 and 4, the decelerated rotation of the carrier CR1 is introduced to the sun gear S2 through the clutch C-3. In addition, the input rotation is introduced to the carrier CR2 by the engagement of the clutch C-2. In this manner, an accelerated rotation slightly faster than the input rotation is produced by the decelerated rotation introduced to the sun gear S2 and the input rotation introduced to the carrier CR2, and is output to the ring gear R2. Thus, the forward rotation as the fifth forward speed is output from the counter gear 11.

In sixth forward speed (6TH), the clutch C-2 is engaged and the brake B-1 is locked, as shown in FIG. 3. Then, as shown in FIGS. 2 and 4, the input rotation is introduced to the carrier CR2 by the engagement of the clutch C-2. In addition, the sun gear S2 is held stationary by the locking of the brake B-1. Then, rotation input to the carrier CR1 is accelerated to a speed faster than that of the fifth forward speed by the fixed sun gear S2, and is output to the ring gear R2. Thus, the forward rotation as the sixth forward speed is output from the counter gear 11.

In first reverse speed (REV), the clutch C-3 is engaged and the brake B-2 is locked, as shown in FIG. 3. Then, as shown in FIGS. 2 and 4, the decelerated rotation of the carrier CR1 is introduced to the sun gear 52 through the clutch C-3. In addition, the carrier CR2 is held stationary (without rotation) by the locking of the brake B-2. Therefore, the decelerated rotation introduced to the sun gear S2 is output to the ring gear R2 through the fixed carrier CR2. Thus, the reverse rotation as the first reverse speed is output from the counter gear 11.

Note that, in the P (parking) range and in the N (neutral) range, the clutches C-1, C-2, and C-3 are disengaged to disconnect the carrier CR1 from the sun gears S2 and S3, that is, the planetary gear SP is disconnected from the planetary gear unit PU, and the input shaft 10 and the carrier CR2 are also disconnected from each other. Consequently, power transmission is disconnected between the input shaft 10 and the planetary gear unit PU, that is, between the input shaft 10 and the counter gear 11.

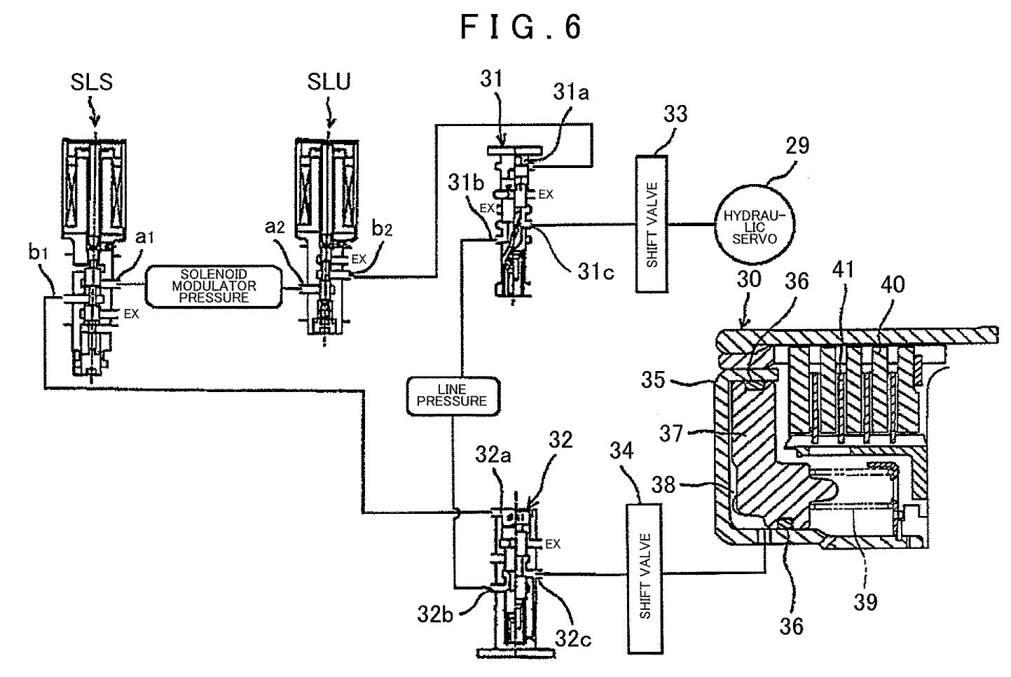

Next, the hydraulic circuit in the hydraulic control device 6 will be described with reference to FIG. 6. The hydraulic circuit has two linear solenoid valves SLS and SLU, and also has a plurality of hydraulic servos 29 and 30 that disconnect and connect the plurality of friction engagement elements for achieving, for example, six forward speeds and one reverse speed by switching the power transmission paths through the planetary gear unit in the automatic speed change mechanism. In addition, a solenoid modulator pressure is supplied to input ports a, and a2 of the linear solenoid valves SLS and SLU, respectively, and control hydraulic pressures from output ports b₁ and b₂ of the corresponding linear solenoid valves are supplied to control fluid chambers 31a and 32a of corresponding pressure control valves 31 and 32, respectively. The pressure control valves 31 and 32 are supplied with a line pressure through input ports 31b and 32b, respectively, and regulated pressures that are regulated by the control hydraulic pressures are supplied from output ports 31c and 32c through shift valves 33 and 34 to the hydraulic servos 29 and 30, respectively, as appropriate.

Note that this hydraulic circuit is illustrated only to the extent necessary to show the basic concept, and thus the hydraulic servos 29, 30 and the shift valves 33, 34 are shown merely as representative of the larger number of hydraulic servos which are provided for controlling the automatic speed change mechanism 5, and the larger number of shift valves for switching hydraulic pressures to the hydraulic servos. As shown in the hydraulic servo 30, the hydraulic servo has a piston 37 that is fit in a cylinder 35 in an oil-tight manner using oil seals 36. Responsive to the regulated hydraulic pressure from the pressure control valve 32 that acts in a hydraulic pressure chamber 38, the piston 37 moves against a return spring 39 to make outer friction plates 40 contact inner friction materials 41 thereby engaging the clutch. Although shown as engaging a clutch, this hydraulic control circuit is also applicable to a brake.

As shown in FIG. 1, the shift control apparatus 1 is applied to an automatic transmission which has a stepped automatic speed change mechanism 5 that introduces rotation of the engine (driving source) 2 to the input shaft 10 and couples the counter gear (output member) 11 to the drive wheels. The clutches C-1, C-2, and C-3, and the brakes B-1 and B-2 serve as friction engagement elements that change the power transmission path between the input shaft 10 and the counter gear 11, and the hydraulic servos (refer to 29 and 30 in FIG. 6) disconnect and connect the friction engagement elements. The automatic speed change mechanism 5 is provided with the sun gear (fixed gear) S1 that is fixed to the transmission case 9 to generate a reaction force against the rotation of the input shaft 10. The shift control apparatus 1 for the automatic transmission achieves an upshift to a predetermined shift speed (for example, fifth speed) by engaging a first friction engagement element (for example, C-3) and disengaging a second friction engagement element (C-1), both of which are included among the plurality of friction engagement elements.

That is, as shown in FIG. 1, the shift control apparatus 1 for the automatic transmission is provided with a control unit (ECU) 12 that receives a signal from the engine (E/G) 2, signals from an input shaft rotational speed sensor 22 and an output shaft rotational speed (vehicle speed) sensor 23 of the automatic transmission 3 (automatic speed change mechanism 5), a signal from the strain gauges 24, a signal from an accelerator opening sensor 25, and a signal from an oil temperature sensor 29. The input shaft rotational speed sensor 22 detects the rotational speed of the input shaft 10, and the output shaft rotational speed sensor 23 detects the rotational speed of the output shaft (not shown) provided on the downstream side of the counter gear 11.

The control unit 12 includes a shift control unit 14, a shift map 18, a torque phase detecting unit 15, an inertia phase detecting unit 28, a torque value calculating unit 16, and an engine speed detecting unit 19. Note that the torque value calculating unit 16 and the strain gauges 24 together form a fixed gear torque detecting unit that detects a value for torque acting on the sun gear S1, based on the reaction force.

The shift control unit 14 issues electrical commands to solenoid valves (not shown) provided in the hydraulic control device 6 to control the hydraulic pressure supplied to the corresponding hydraulic servos (refer to 29 and 30 in FIG. 6) for the clutches C-1, C-2, and C-3, and the brakes B-1 and B-2 that serve as friction engagement elements, thereby shifting speeds by switching engagement among those clutches and brakes. For example, in the case of a power-on upshift, the shift control unit 14 refers to the shift map 18, applying the vehicle speed that is calculated from, for example, the rotational speed of the output shaft (not shown) of the automatic speed change mechanism S detected by the output shaft rotational speed sensor 23, and the accelerator opening detected by the accelerator opening sensor 25. Then, if the accelerator opening is at least a predetermined amount and if an upshift point is judged, the shift control unit 14 issues the commands to the solenoid valves (not shown) in the hydraulic control device 6 to switch engagement among the friction engagement elements in the automatic speed change mechanism 5, thereby making the power-on upshift. The shift control unit 14 includes an engaging-side hydraulic pressure control unit 13a that controls the engaging-side hydraulic pressure acting on the hydraulic servo for the first friction engagement element (for example, C-3) during the torque phase, and a disengaging-side hydraulic pressure control unit 13b that controls the disengaging-side hydraulic pressure acting on the hydraulic servo for the second friction engagement element during the torque phase, the engaging-side hydraulic pressure control unit 13a and the disengaging-side hydraulic pressure control unit 13b controlling the engaging-side hydraulic pressure and the disengaging-side hydraulic pressure, respectively, based on the result obtained by the torque phase detecting unit 15.

The torque value calculating unit 16 calculates the torque value acting on the sun gear S1 based on the outputs of the strain gauges 24. That is, the torque value calculating unit 16 is electrically connected to the strain gauges 24 so as to apply an electrical signal to the strain gauges 24 and to receive an electrical signal from the strain gauges 24 that is indicative of the strain on the sun gear S1. Then, the torque value calculating unit 16 calculates the value for torque acting on the sun gear S1 based on the signal from the strain gauges 24. More specifically, the torque value calculating unit 16 has an amplifier (not shown) for amplifying the output signal from the strain gauges 24, and calculates (detects) the torque value acting on the sun gear S1 based on the output voltage of the strain gauges 24 amplified by the amplifier.

The torque phase detecting unit 15 detects the start of a torque phase at which only torque distribution changes while the gear ratio stays at the level (for example, fourth speed) before upshift, based on a change in the torque value detected by the strain gauges 24 and the torque value calculating unit 16. In the present embodiment, the input torque is obtained by multiplying the torque value acting on the sun gear S1 (torque distributed to the sun gear) by, for example, 1.7985 at a shift speed between the first speed (1ST) and the third speed (3RD), by multiplying the torque distributed to the sun gear by, for example, 6.25 at the fourth speed (4TH), or by multiplying the torque distributed to the sun gear by, for example, −6.76 at the fifth speed (5TH). At the sixth speed (6TH), it is impossible to measure the input torque (0) because the rotation of the input shaft 10 is transmitted to the counter gear 11 only through the planetary gear unit PU without passing through the planetary gear set SP. As described above, the change in the torque value detected by the strain gauges 24 and the torque value calculating unit 16 appears prominently during shifting between comparatively high shift speeds (for example, 3rd-to-4th shifting, 4th-to-5th shifting, or 5th-to-6th shifting), and thus the torque phase detecting unit 15 detects the start of the torque phase by determining the time when the torque value prominently changes as an end of a piston stroke (end of so-called backlash reduction). The torque phase detecting unit 15 compares the detected prominent change in torque value with a threshold value, and determines the start of the torque phase as when the torque value has exceeded the threshold value.

The inertia phase detecting unit 28 detects a start of an inertia phase at which a gear ratio change starts in the automatic speed change mechanism 5, based on the change in the torque value detected by the torque value calculating unit 16 and the strain gauges 24. That is, the inertia phase detecting unit 28 detects the start of the inertia phase at which the gear ratio change starts in the automatic speed change mechanism 5, based on the torque value calculated by the torque value calculating unit 16. The inertia phase detecting unit 28 has a preset threshold value, and by judging whether or not the torque value calculated by the torque value calculating unit 16 has exceeded the threshold value, determines that the inertia phase has started if the torque value has exceeded the threshold value.

Signals including an engine torque signal are sent from the engine 2 to the control unit 12, and based on the signals from the engine 2, the engine speed detecting unit 19 detects the rotational speed of the engine 2 (hereinafter called “engine speed”).

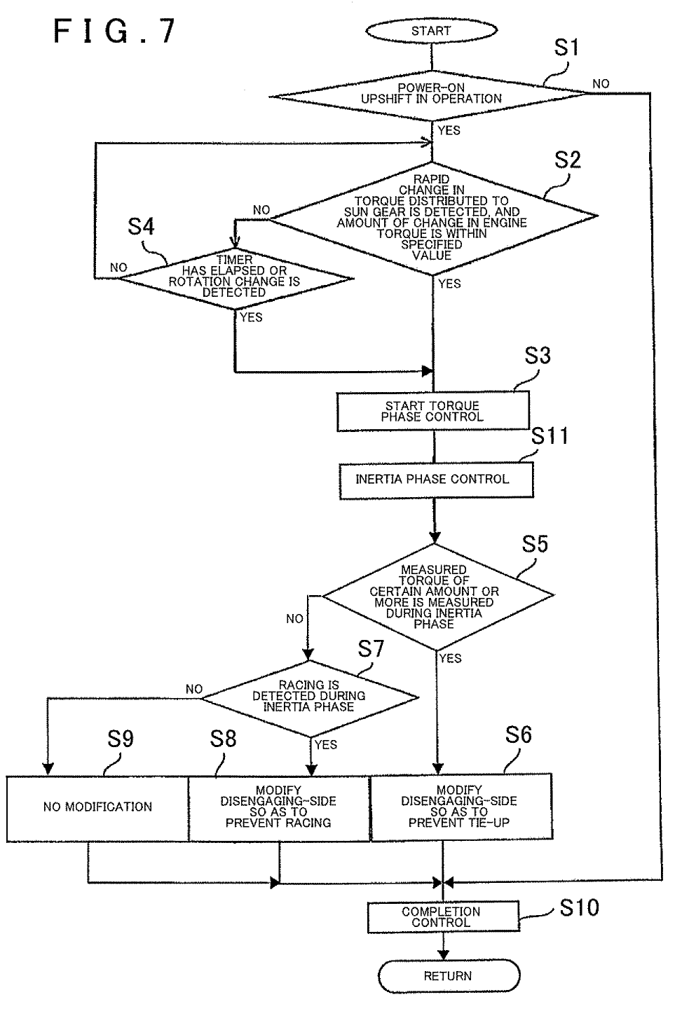

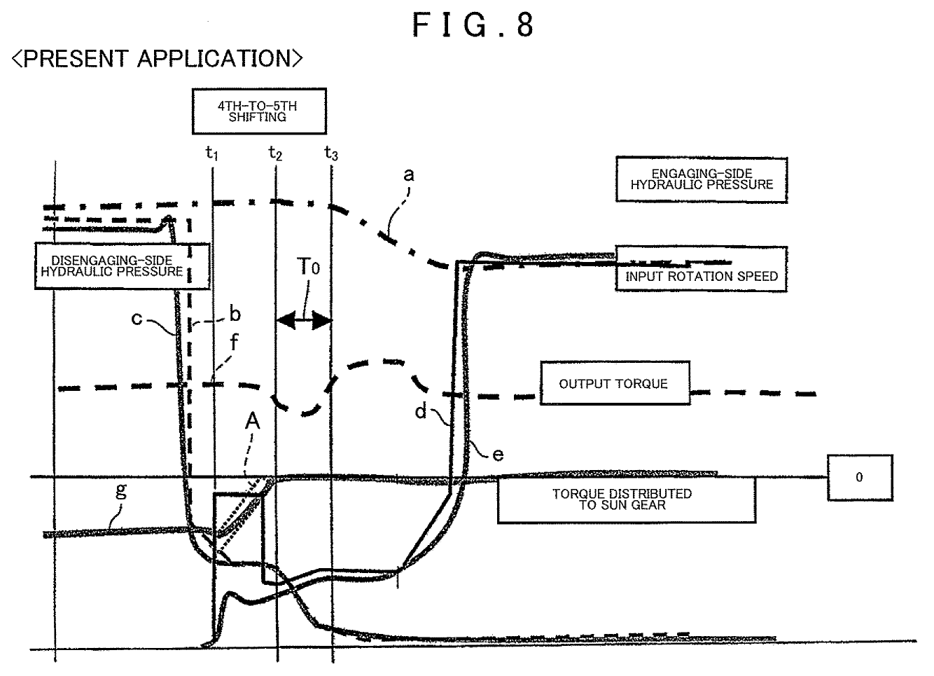

Next, the control by the shift control apparatus 1 for the automatic transmission will be described with reference to FIG. 1, the flow chart in FIG. 7, and the time charts in FIGS. 8 to 12.

FIG. 8 shows the time chart illustrating changes in parameters during 4th-to-5th shifting, in which “a” represents the change in input rotational speed of the input shaft 10 of the automatic speed change mechanism 5; “b” represents the hydraulic pressure command value on the disengaging side; “c” represents the disengaging-side hydraulic pressure; “d” represents the hydraulic pressure command value on the engaging side; “e” represents the engaging-side hydraulic pressure; “f” represents the output torque “g” represents the torque value acting on the sun gear S1 (torque distributed to the sun gear); and To indicates the torque phase.

The control by the shift control apparatus 1 starts, for example, when the ignition switch (not shown) is turned on and the engine 2 is powered on, and waits until detection of the power-on upshift by the shift control unit 14. Then, while the vehicle is running under control of accelerator pedal operation by the driver at, for example, the fourth speed, the shift control unit 14 refers to the shift map 18, applying the vehicle speed calculated from the rotational speed of the output shaft of the automatic speed change mechanism 5 detected by the output shaft rotational speed sensor 23, and the accelerator opening detected by the accelerator opening sensor 25. If the detected accelerator opening is at least the predetermined opening and if the upshift point is judged (step S1: YES), the shift control unit 14 performs the power-on upshift, for example, from 4th to 5th speed.

Thus, when a predetermined time has passed from the time when the accelerator opening has been increased by the driver^{t}s pressing down on the accelerator pedal to cross over the shift point from the fourth speed region to the fifth speed region in the shift map 18, the shift control unit 14 judges a 4th-to-5th shift. Then, after a predetermined time for a preprocessing, e.g. a predetermined shift valve operation, has passed, the shift control is started to control the engaging-side hydraulic pressure and the disengaging-side hydraulic pressure by the engaging-side hydraulic pressure control unit 13a and the disengaging-side hydraulic pressure control unit 13b, respectively. Note that, in the foregoing shift control, the driver holds the operation of the accelerator pedal at a substantially constant level, and during the shifting, the upshift control is performed in the power-on state in which power is transmitted from the engine to the drive wheels.

In control of the 4th-to-5th shift, the disengaging-side hydraulic pressure control unit 13b steeply lowers the disengaging-side hydraulic pressure to gradually disengage the clutch C-1, and the engaging-side hydraulic pressure control unit 13a increases the engaging-side hydraulic pressure (at time t₁) to reduce backlash in the hydraulic servo for the clutch C-3 and then to gradually engage the clutch C-3. In this case, because a rapid torque change occurs in the torque g distributed to the sun gear, as shown by the dashed line A after the time t₁ in FIG. 8, the torque phase detecting unit 15 detects the start of the torque phase at which only the torque distribution changes while the gear ratio stays at the same level as before the upshift.

In fourth speed, the rotation of the input shaft 10 is first transmitted from the ring gear R1 through the pinion P1 to the carrier CR1 that receives the reaction force of the sun gear S1, then transmitted from the carrier CR1 through the clutch C-1 to the sun gear S3, further transmitted to the ring gear R2 through the short pinion PS and the long pinion PL that are supported by the carrier CR2 connected to the input shaft 10 by the clutch C-2, and finally transmitted from the ring gear R2 through the counter gear 11 to the output shaft. When shifted from the fourth speed to fifth speed, the rotation of the input shaft 10 is transmitted from the ring gear R1 to the carrier CR1 in the same manner as described above. Then, the rotation of the carrier CR1 is transmitted from the sun gear S2 to the ring gear E2 only through the long pinion PL because the clutch C-3 is engaged instead of the clutch C-1. Then, the rotation is transmitted from the ring gear R12 through the counter gear 11 to the output shaft. At this time, the sun gear S1 receives the reaction force from the pinion P1 and strain is thereby generated at its shaft portion 26, which strain is detected by the strain gauges 24. As a result, the torque value calculating unit 16 receives an electrical signal output from the strain gauges 24 indicative of the strain on the sun gear S1, and calculates the torque value acting on the sun gear S1. Then, the torque phase detecting unit 15 compares the torque value calculated by the torque value calculating unit 16 with the predetermined threshold value, and determines that the torque phase (time t₂ to t₃) has started if the detected torque value has exceeded the predetermined threshold value.

When a rapid change in the torque distributed to the sun gear is detected as described above, the shift control unit 14 judges in step S2 whether or not the amount of change in the engine torque simultaneously lies within a specified range. If it is judged that these conditions are simultaneously satisfied (S2: YES), the shift control unit 14 starts torque phase control that controls both the engaging-side hydraulic pressure and the disengaging-side hydraulic pressure (S3). In the torque phase control, the torque supported by the engaging-side clutch (clutch C-3 in the case of 4th-to-5th shifting) increases whereas the torque supported by the disengaging-side clutch (clutch C-l in the case of 4th-to-5th shifting) decreases, and thus only the torque distribution changes while the gear ratio stays at the same level (fourth speed) as before the upshift.

On the other hand, in the case of an upshift to a comparatively low shift speed, such as 1st-to-2nd shifting or 2nd-to-3rd shifting, in which no rapid change in the torque distributed to the sun gear is observed as detected by the strain gauges 24, that is, a rapid change is not detected and the amount of change in the engine torque is not within the specified range, the process proceeds to step S4, and the torque phase control is started at step S3 after the lapse of a specified time or according to determination of the gear ratio change in a known manner (S4: YES).

Moreover, subsequent to the torque phase control, inertia phase control that changes the engine speed by providing a load torque to the engine is executed (step S11). That is, when the inertia phase control that performs actual shifting in the automatic speed change mechanism 5 has started, the input rotational speed is increased in response to the increase in the engine speed along with the slip of the clutch C-3, and the automatic speed change mechanism 5 is gradually shifted to the fifth speed, that is, a shift progress ratio gradually increases.

Subsequently, at step S5, it is judged whether or not the torque measured during the inertia phase is at least a predetermined amount, and if at least that amount (S5: YES), a learning correction is performed to modify the disengaging-side hydraulic pressure so as to prevent a tie-up (state in which both elements are concurrently connected [simultaneously engaged]). On the other hand, if at least the predetermined amount of torque has been measured in the step S5 (S5: NO), it is judged whether or not an engine racing state has been detected during the inertia phase, in step 87. If the engine racing state has been detected (S7: YES), the learning correction is performed to modify the disengaging-side so as to prevent the engine racing (S8), whereas if not detected (S7: NO), the modification is not performed (S9). Note that engine racing is a state occurring when both the engaging-side friction engagement element and the disengaging-side friction engagement element are concurrently disconnected.

Next, completion control is performed in step S10. That is, in the completion control, the same time as remaining time of the completion control in the disengaging-side hydraulic pressure control is set in the timer, and the engaging-side hydraulic pressure is swept up at a predetermined gradient. The sweep-up is continued until the predetermined time set above has elapsed, at which time the completion control is ended. Thus, the 4th-to-5th shift is completed.

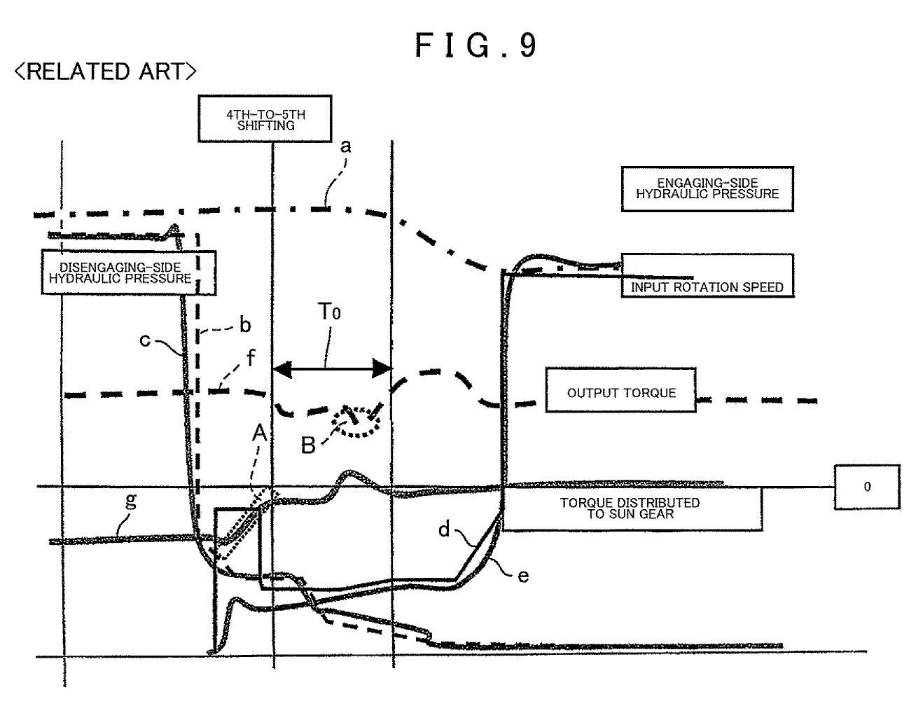

Here, shift control for an automatic transmission of the related art type will be described with reference to FIG. 9. That is, because, in the related art, the end of the piston stroke has not been accurately identified during shifting between high gear stages, the time To of the torque phase has been long, and therefore tie-up has tended to occur during shifting, as shown in the area B shown encircled by a dashed line.

According to the present embodiment described above, the strain gauges 24 and the torque value calculating unit 16 detect the torque value acting on the sun gear S1 based on the reaction force, and the torque phase detecting unit 15 detects the start of the torque phase in which only the torque distribution changes while the gear ratio stays at the same level before the upshift, based on the change in the torque value detected by the strain gauges 24 and the torque value calculating unit 16. Consequently, when upshifting by switching frictional engagement elements, such as in a clutch-to-clutch shift, the end of the piston stroke can be accurately determined by precisely detecting the torque phase during the shift, thereby enabling improvement in responsiveness during the shifting, reduction of waiting time, and elimination of possibility of occurrence of problems such as burning of friction materials due to excessive heat generation in the friction engagement elements. In addition, because the torque phase detecting unit 15 detects the start of the torque phase, the end of the piston stroke can be accurately determined in a region in which the piston stroke could not previously be determined, i.e. shifting between high gear stages. Therefore, by using the present invention in the learning control of the engagement pressure of the piston stroke, the piston stroke at a comparatively high gear stage can be optimized, thus enabling effective prevention of engine racing and excessive heat generation.

In addition, in the present embodiment, the change in the torque value detected by the strain gauges 24 and the torque value calculating unit 16 appears prominently during shifting between comparatively high shift speeds, and the torque phase detecting unit 15 detects the start of the torque phase by determining the time at which the torque value prominently changes as the end of the piston stroke. As a result, the start of the torque phase can be easily detected by detecting the prominent change in the value for torque acting on the sun gear S1.

Moreover, in the present embodiment, the fixed gear torque detecting unit is composed of the strain gauges 24 that detect the strain between the sun gear S1 and the transmission case 9 caused by the torque acting from the input shaft 10 side, and the torque value calculating unit 16 that calculates the torque value acting on the sun gear S1 based on the output of the strain gauges 24. As a result, a structure for easily detecting the strain between the sun gear S1 and the transmission case 9 is obtained by using the strain gauges 24 of a simple structure and comparatively low cost and by, for example, directly adhering the strain gauges 24 on a part of the sun gear S1. Consequently, it is possible to detect torque values which can be used for detecting the torque phase with an extremely simple structure.

Also, in the present embodiment, the engaging-side hydraulic pressure control unit 13a and the disengaging-side hydraulic pressure control unit 13b respectively control, during the torque phase, the engaging-side hydraulic pressure acting on the hydraulic servo for the first friction engagement element (for example, C-3) and the disengaging-side hydraulic pressure acting on the hydraulic servo for the second friction engagement element (for example, C-1), based on the determination made by the torque phase detecting unit 15. Consequently, although the end of the piston stroke could not be accurately identified in the related art, particularly during shifting between high gear stages, the present invention enables accurate identification of the end of the piston stroke by use of the torque phase detecting unit 15, thereby making switching to the torque phase control quicker than the switching in the related art and enabling prevention of excessive heat generation in the friction engagement elements during the torque phase.

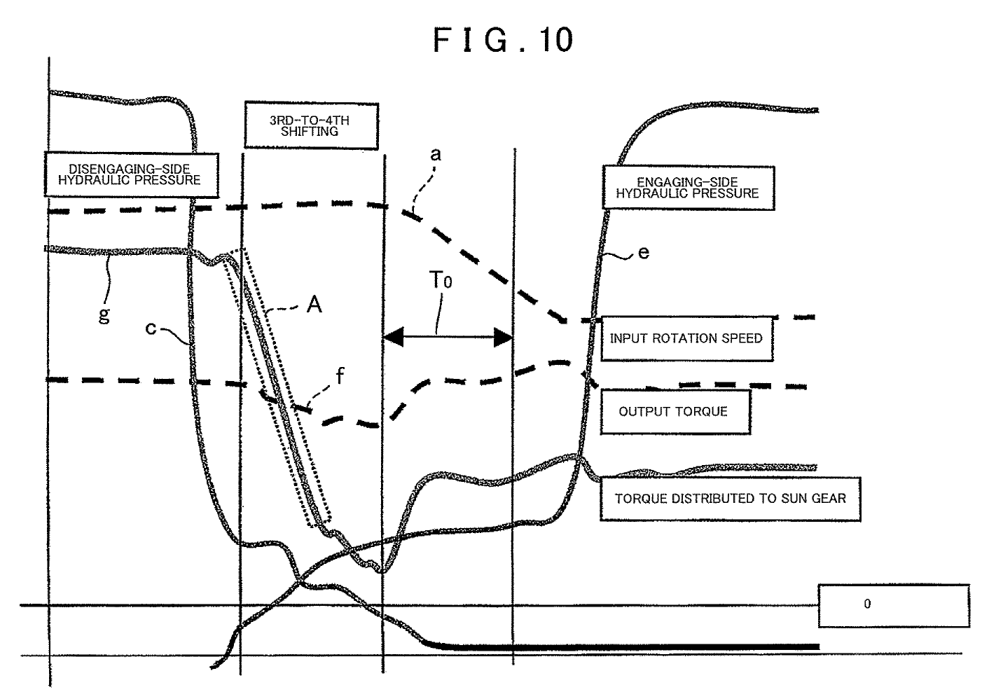

A modification of the above-described embodiment will now be described with reference to FIGS. 10 to 12. In FIGS. 10 to 12, “d” shows the change in input rotational speed of the input shaft 10; “c” represents the disengaging-side hydraulic pressure; “e” represents the engaging-side hydraulic pressure; “f” represents the output torque, “g” represents the value of the torque acting on the sun gear S1 (torque distributed to the sun gear); and To represents the torque phase.

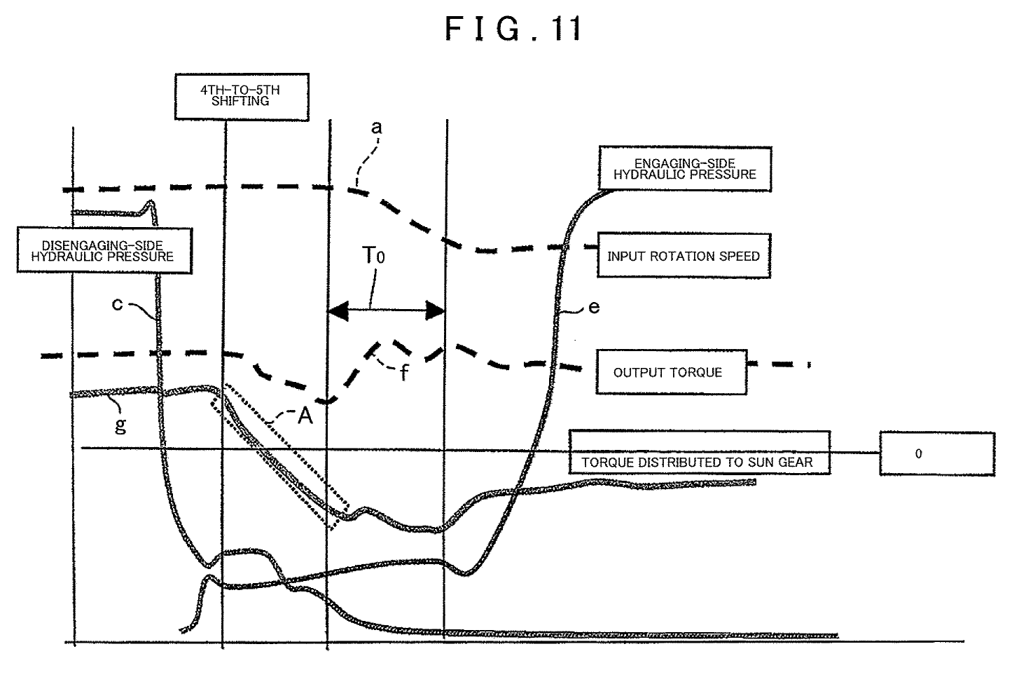

In the modified example of the 3rd-to-4th shift shown in FIG. 10, a rapid torque change in the torque g distributed to the sun gear appears in the portion of g shown encircled by a dashed line A. Also, in the modified example for the 4th-to-5th shifting shown in FIG. 11, a rapid torque change in the torque g distributed to the sun gear appears in the section of the line “g” encircled by dashed line A.

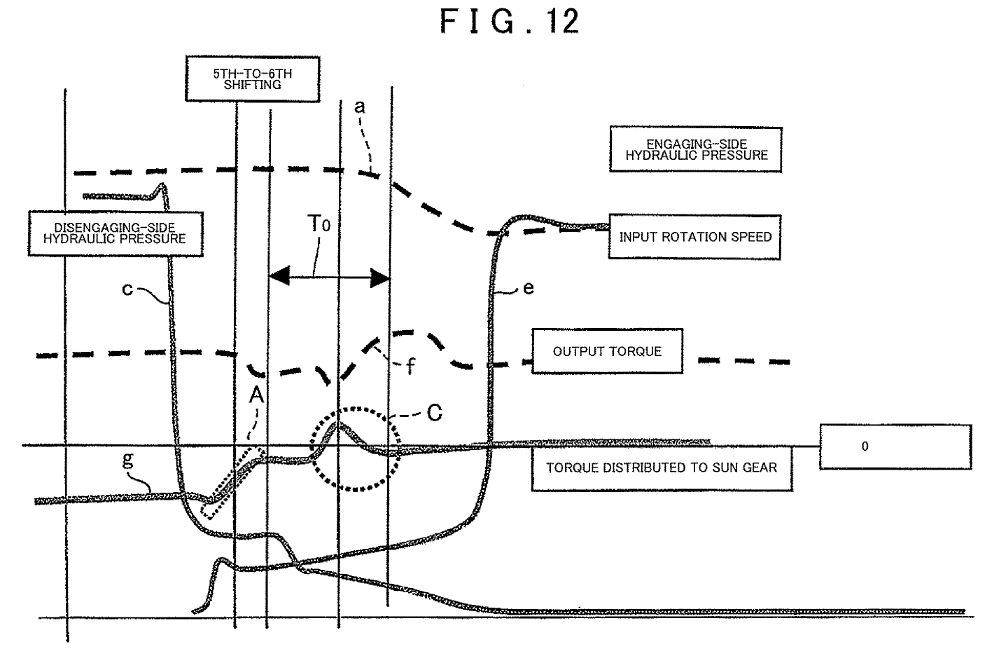

A rapid torque change in the torque g distributed to the sun gear also appears in the section of g encircled by a dashed line A in the modified example for the 5th-to-6th shift shown in FIG. 12. The torque distributed to the sun gear is 0 at the sixth speed as described above, but is not 0 when the tie-up occurs, because of the influence of torque distribution. Therefore, the state of the tie-up during the shift can be detected because the tie-up appears in the section of line g encircled by a dashed line C of the torque g distributed to the sun gear.

Note that, in the foregoing embodiment and the modifications thereof described above, reference has been made to use in an FF type vehicle, and to an automatic transmission 3 that achieves six forward speeds and one reverse speed. However, the present invention is not limited to this application, and can also be applied to an automatic transmission suitable for use in a vehicle of FR (front engine, rear drive) type or any other type, provided the automatic transmission has a planetary gear set with a gear (for example, a sun gear) constantly fixed to the transmission case.

The shift control apparatus for an automatic transmission according to the present invention can be used in an automatic transmission mounted in a passenger vehicle, truck, bus, agricultural machine, or the like, and is particularly suitable for use in an automatic transmission for which the torque phase must be detected during shifting.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A shift control apparatus for an automatic transmission including a stepped speed change mechanism that receives rotation of a driving source at an input shaft and couples an output member to drive wheels, wherein the stepped speed change mechanism has a plurality of friction engagement elements that change power transmission paths between the input shaft and the output member, and hydraulic servos that disconnect and connect the friction engagement elements, wherein the speed change mechanism includes a fixed gear that is fixed to a transmission case to generate a reaction force against the rotation of the input shaft, and achieves an upshift to a predetermined shift speed by engaging a first friction engagement element and disengaging a second friction engagement element, the shift control apparatus comprising:
a fixed gear torque detecting unit that detects, based on the reaction force, a value for torque acting on the fixed gear; and
a torque phase detecting unit that detects, based on a change in the value for torque detected by the fixed gear torque detecting unit, start of a torque phase in which only distribution of torque changes while a gear ratio stays at the same level as before the upshift.

2. The shift control apparatus for an automatic transmission according to claim 1, wherein:
the change in the value for torque detected by the fixed gear torque detecting unit appears prominently during shifting between high shift speeds, and
the torque phase detecting unit detects the start of the torque phase by determining the time when the value for torque prominently changes as an end of a piston stroke.

3. The shift control apparatus for an automatic transmission according to claim 2, wherein the fixed gear torque detecting unit is composed of:
a strain detecting sensor that detects strain between the fixed gear and the transmission case caused by torque from the input shaft; and
a torque value calculating unit that calculates the value for torque acting on the fixed gear, based on the strain detected by the strain detecting sensor.

4. The shift control apparatus for an automatic transmission according to claim 3, further comprising:
a hydraulic pressure control unit that controls, during the torque phase, an engaging-side hydraulic pressure acting on the hydraulic servo for the first friction engagement element and a disengaging-side hydraulic pressure acting on the hydraulic servo for the second friction engagement element, wherein
the hydraulic pressure control unit controls the engaging-side hydraulic pressure and the disengaging-side hydraulic pressure, based on detection of the torque phase by the torque phase detecting unit.

5. The shift control apparatus for an automatic transmission according to claim 4, wherein the speed change mechanism includes:
a decelerating planetary gear set that is capable of outputting rotation at a speed that is decelerated from the rotational speed of the input shaft;
a planetary gear unit that has four rotary elements including an output element connected to the output member of the speed change mechanism;
two decelerating clutches that, upon engagement, transmit rotation of the decelerating planetary gear set, respectively, to two of the rotary elements of the planetary gear unit; and
an input clutch that, upon engagement, transmits rotation of the input shaft to one of the rotary elements of the planetary gear unit, thereby achieving five or six forward speeds, and
the fixed gear is a gear that is constantly held without rotation in the decelerating planetary gear set.

6. The shift control apparatus for an automatic transmission according to claim 5, wherein
the decelerating planetary gear set includes a sun gear that is fixed to the transmission case, a ring gear that outputs the decelerated rotation, and a carrier that receives the rotation of the input shaft, and
the fixed gear is the sun gear.

7. The shift control apparatus for an automatic transmission according to claim 1, wherein the fixed gear torque detecting unit includes:
a strain detecting sensor that detects strain between the fixed gear and the transmission case caused by torque from the input shaft; and
a torque value calculating unit that calculates the value for torque acting on the fixed gear, based on the strain detected by the strain detecting sensor.

8. The shift control apparatus for an automatic transmission according to claim 1, further comprising:
a hydraulic pressure control unit that controls, during the torque phase, an engaging-side hydraulic pressure acting on the hydraulic servo for the first friction engagement element and a disengaging-side hydraulic pressure acting on the hydraulic servo for the second friction engagement element, wherein
the hydraulic pressure control unit controls the engaging-side hydraulic pressure and the disengaging-side hydraulic pressure, based on detection of the torque phase by the torque phase detecting unit.

9. The shift control apparatus for an automatic transmission according to claim 1, wherein the speed change mechanism includes:
a decelerating planetary gear set that is capable of outputting rotation at a speed that is decelerated from the rotational speed of the input shaft;
a planetary gear unit that has four rotary elements including an output element connected to the output member of the speed change mechanism;
two decelerating clutches that, upon engagement, transmit rotation of the decelerating planetary gear set, respectively, to two of the rotary elements of the planetary gear unit; and
an input clutch that, upon engagement, transmits rotation of the input shaft to one of the rotary elements of the planetary gear unit, thereby achieving five or six forward speeds, and
the fixed gear is a gear that is constantly held without rotation in the decelerating planetary gear set.
